(19) United States
(12) Patent Application Publication
(10) Pub. No.: US 2007/0215641 A1
(43) Pub. Date: Sep. 20, 2007

(54) Storage and application of post-foaming compositions

(76) Inventors: Yoram Fishman, Los Angeles, CA (US); Ian Fishman, Los Angeles, CA (US)

Correspondence Address: KONRAD RAYNES & VICTOR, LLP, 315 S. BEVERLY DRIVE, # 210, BEVERLY HILLS, CA, 90212, US

(21) Appl. No.: 11/384,610

(22) Filed: Mar. 20, 2006

(51) Int. Cl. B67D 1/08; B65D 35/00; B65D 47/00

(52) U.S. Cl. 222/151; 222/92; 222/546; 222/563; 222/543

(57) ABSTRACT

Embodiments relate to the application and storage of post-foaming compositions. One example includes a product including a deformable tube including a neck region at one end, the neck region defining an interior passage. The product also includes a cap configured to be coupled to and removed from the neck region. A post-foaming composition is contained in the tube and adapted to be delivered from the tube through the interior passage in the neck region upon the application of force to the tube. The cap includes a protuberance configured to extend into the interior passage when the cap is coupled to the neck region. Other embodiments are described and claimed.

### FIELD OF THE INVENTION

Embodiments of the present invention relate to the storage and application of post-foaming compositions.

### DESCRIPTION OF THE RELATED ART

A common form of shaving preparation is referred to as a post-foaming preparation (also known as self-foaming), in which a product is initially delivered in a non-foam form, such as, for example, a gel. When rubbed on the skin, for example, the warmth causes the product to turn into a foam. Such post-foaming preparations typically include a small quantity of a propellant such as one or more hydrocarbons, and a cosmetic mixture including one or more of a gel, emulsion, or suspension, which is hydrated. For example, one class of post-foaming shaving preparations includes an oil in water emulsion formulated as a gel. The preparation is contained in a multi-compartment can having the preparation in one compartment and a gas driven piston in another compartment. Upon actuation by the user, the piston presses on the compartment containing the preparation to deliver the product to the user, who then rubs the product to form a foam lather that is applied to the skin to be shaved. Other types of cosmetic products, for example, hair products, may also be formed from self-foaming compositions.

The use of a pressurized container having a gas-driven piston has certain problems. For instance, the multi-compartment can and piston structure is somewhat complicated and expensive to produce. Furthermore, even when the product in the container is used up, the gas in the gas-driven piston compartment remains, which may lead to disposal problems. In addition, such a pressurized container including the gas-driven piston is not permitted into the passenger compartment of a commercial airliner.

### BRIEF DESCRIPTION OF THE DRAWINGS

Certain embodiments of the invention are described with reference to the accompanying drawing which, for illustrative purposes, are schematic and not drawn to scale.

FIG. 1 illustrates a view of a tube having a post-foaming product therein and a cap with a protuberance, in accordance with certain embodiments.

FIG. 2 illustrates a cross-sectional view of a tube having a post-foaming product therein and a cap with a protuberance, in accordance with certain embodiments.

FIG. 3 illustrates a cross-sectional view of the structure of a tube having a post-foaming product therein and a cap with a protuberance, with the cap positioned on the tube, in accordance with certain embodiments.

FIGS. 4(a)-4(c) illustrate cross-sectional views of a protuberance extending various distances into a portion of a tube, in accordance with certain embodiments.

FIG. 5 illustrates a view of a tube having a post-foaming product therein, a cap with a protuberance, and a mechanism for coupling the cap to the tube, in accordance with certain embodiments.

### DETAILED DESCRIPTION

Certain embodiments of the present invention relate to the application and storage of post-foaming compositions such as cosmetics.

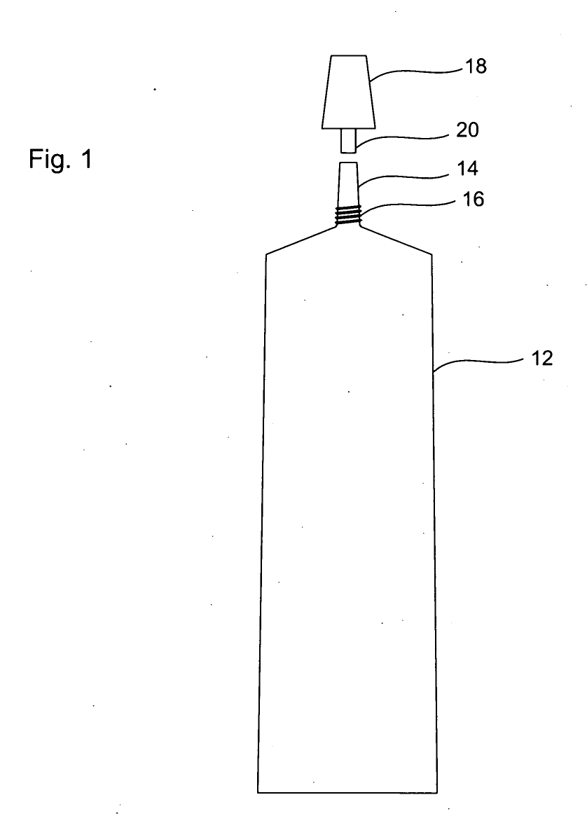

FIG. 1 illustrates an embodiment including a deformable tube 12 having a neck region 14 and a cap 18. The cap 18 is configured to fit over at least part of the neck region 14. As illustrated in FIG. 1, the neck region 14 of the tube 12 includes a treaded region 16 over which a the cap 18 can be fit. Other types of engagement between the cap and neck region are possible, for, example, a snap fit. The cap 18 also includes a protuberance 20 extending therefrom. The protuberance 20 is configured to extend into the neck region 14 when the cap 18 is placed on the neck region 14. The tube 12 houses a post-foaming composition therein, which may be delivered to a user by squeezing the tube 12, which delivers the composition through the neck region 14 and out of the tube. The tube 12 may in certain embodiments be formed from a metal such as aluminum, and may have an appearance somewhat similar to that of a toothpaste tube. By forming the tube 12 from a deformable material, the contents of the tube can be pressed upwards through the tube by the application of pressure such as pressing the sides of the tube 12. It is desirable to avoid the formation of air cavities within the tube 12, to inhibit product degradation. The cap 18 and protuberance 20 may in certain embodiments be formed from a rigid material such as, for example, a polymer.

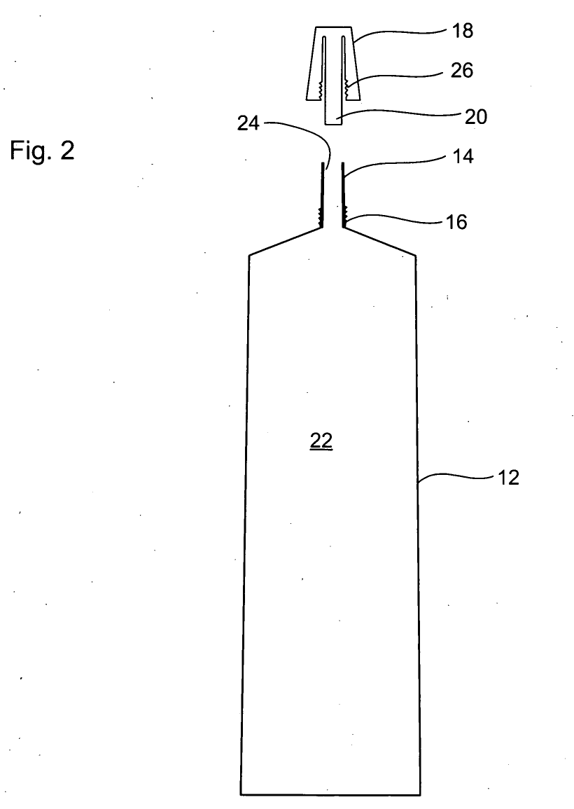

FIG. 2 illustrates a cross-sectional view of the components of FIG. 1. The tube 12 includes interior compartment 22, which extends through the passage 24 defined by the interior surface of the neck region 14. The cap 18 includes threaded region 26, which is configured to fit into the threaded region 16 of the neck region 14. The protuberance 20 may be formed integral to the cap 18. Alternatively, the protuberance 20 may be a separate component that fits into or is otherwise attached to an interior portion of the cap 18.

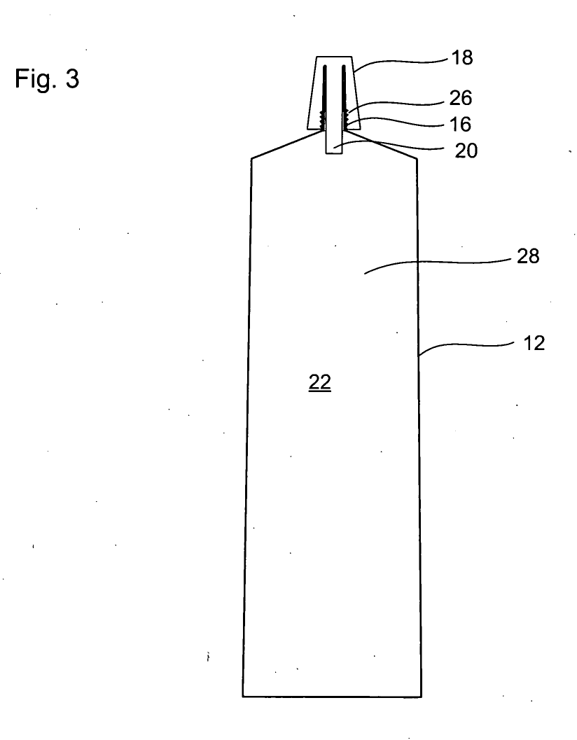

FIG. 3 is a cross-sectional view illustrating the cap 18 being positioned on the neck region 14. The protuberance 20 is configured to extend all the way through and beyond the passage 24 and extend into the interior compartment 22 below the neck region 14. A purpose of the protuberance is to inhibit the post-foaming composition 28 in the compartment 22 from flowing into the neck region 14. In certain embodiments, the protuberance 20 may have a rod-like shape and be configured to provide a snug fit within the passage, 24 in the neck region 14.

Use of an embodiment of the invention is as follows. A user unscrews or otherwise removes the cap 18 from the neck region 14. The user then applies a force to the tube, which will force the post-foaming composition 28 through the passage 24 of the neck region and out of the tube into the user's hands, for example. The tube may in certain aspects feel like a toothpaste tube when pressed. The user may then rub the hands together or rub the hand with the post-foaming composition 28 on the face or other desired location. The post-foaming composition 28 will then foam up and can be used as desired. If nothing is done after the cap 18 is removed, then a quantity of the post-foaming composition 28 may start to dribble or run out of the neck portion 14 of the tube 12. If the post-foaming composition 28 sits on the user's hands without being rubbed, it will start to foam after it has absorbed sufficient heat from the environment (generally in less than a minute).

After the desired quantity has been dispensed, the user replaces the cap 18 on the neck region 14 of the tube 12, placing the protuberance 20 into the passage 24 in the neck region 14 to force an amount of the composition 28 that is in the neck region 14 back through the neck region 14, so that the next time the cap 18 is removed, a space will exist in the neck region 14 for at least a short time. By configuring the protuberance 20 to extend through at least part of the neck region 14, the user has sufficient time to aim the tube 12 as desired and be able to control the initial flow and application of the post-foaming composition 28 after the tube 12 is opened and squeezed. If there were no protuberance 20, as the user opens the tube, the post-foaming composition would start to come out of the tube 12 quickly and control would be difficult.

The protuberance 20 may in certain embodiments extend partially through the passage 24 in the neck region 14, and in other embodiments, extend all the way through the passage 24 in the neck region 14.

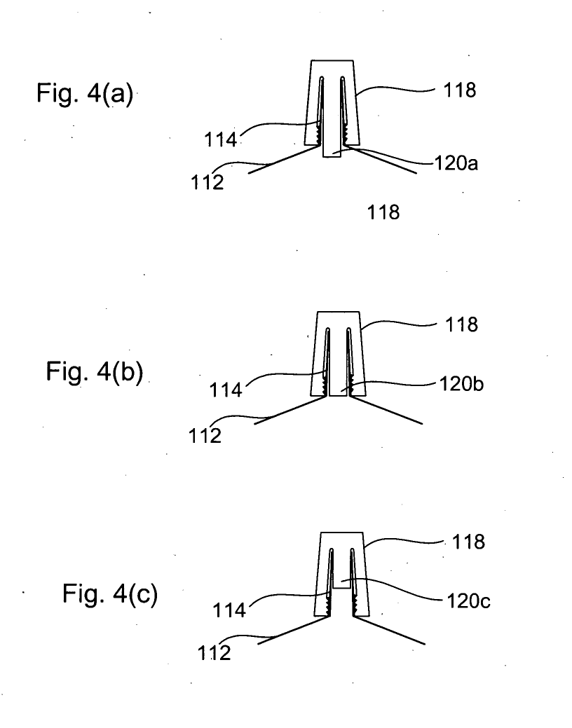

FIGS. 4(a)-(c) illustrate cross-sectional views of a cap 118 on a neck region 114 of a tube 112, in accordance with a number of embodiments. FIG. 4(a) illustrates the cap 120 including protuberance 120a extending through the entire length of the neck region 114 and beyond. FIG. 4(b) illustrates the cap 118 including protuberance 120b extending the same length as the neck region 114. FIG. 4(c) illustrates the cap 118 including protuberance 120c extending partially through the length of the neck region 114. The length of the protuberance may in certain embodiments be varied depending on factors such as the length of the neck region of the tube and the exact flow characteristics of the post-foaming composition in the tube. In certain embodiments, the length of the protuberance is preferably at least one half the length of the neck region. In other embodiments, the protuberance is at least the same length as the neck region.

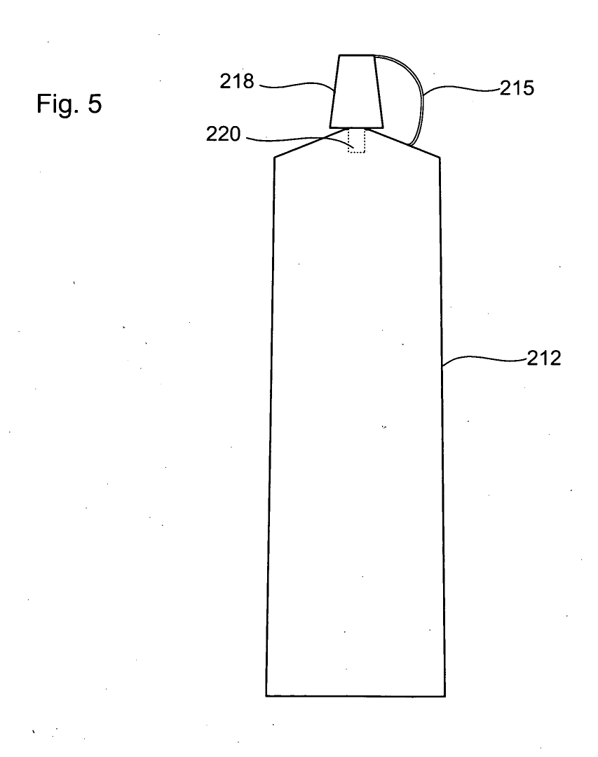

FIG. 5 illustrates an embodiment in which the cap 218, having protrusion 220 (partially shown as a dotted line extending into tube 212), is coupled to the tube 212 regardless of whether the tube 212 is opened or closed by the cap 218. This embodiment includes a leash 215 for coupling the cap 218 to the tube 212. The leash may take the form of a strap or other mechanism coupled to both the tube 212 and the cap 218.

A variety of post-foaming formulations, including cosmetic compositions known in the art, may be used in embodiments of the present invention. For example, in certain embodiments, the post-foaming composition will include a concentrate containing about 2-6 wt % of a propellant such as one or more hydrocarbons. This quantity of the propellant acts as a foaming agent, which will volatilize and turn the dispensed formulation into a foam when rubbed in the hands or on the body. Formulations may include any suitable post-foaming cosmetic including, but not limited to, shaving formulations, hair care and styling products, facial and body wash products, facial and body moisturizer products, and make-up products.

Table 1 sets forth a post-foaming shaving formulation used in accordance with an embodiment of the present invention. The formulation takes the form of a gel when dispensed from a tube such as described above.

TABLE 1
Example of post-foaming shave gel formulation.

| Ingredient (or trade name) | amount (wt %) |
|---|---|
| Purified Water | 67.96530 |
| Carbomer (CARBOPOL ULTREZ 10) | 0.38200 |
| Propylene Glycol | 3.34250 |
| Hydroxypropyl Guar | 0.24830 |
| Methylparaben | 0.19100 |
| Palmitic Acid | 10.02750 |
| Triethanolamine 85% | 8.83380 |
| Isopropyl Palmitate | 2.38750 |
| Triclosan | 0.28650 |
| Aloe Barbadensis Leaf Juice | 0.04780 |
| Blue 1 (CI 42090) | 0.00140 |
| Yellow 5 (CI 19140) | 0.00050 |
| Sodium Isostearyl Lactylate | 0.28650 |
| Fragrance | 1.49940 |
| Isobutane | 0.67500 |
| Isopentane | 3.82500 |
| total | 100.00000 |

The post-foaming shave gel formulation of Table 1 may be formed as follows. First, the purified water is charged into a main mixing tank. With high-speed agitation to form a vortex, the CARBOPOL ULTREZ 10 is sprinkled into the vortex and mixed until completely hydrated. Then heating is started to heat the batch to 80-85° C. In a separate container, the hydroxypropyl guar and the propylene glycol are mixed until uniform and then added to the batch in the main mixing tank. While heating, the methyl paraben and the palmitic acid are added to the batch. When the batch reaches 80° C., the triethanolamine is added and the batch mixed until uniform. In a separate container, the isopropyl palmitate and Triclosan are premixed and then added to the batch in the main mixing tank. Then the batch is cooled. At 70° C., the aloe barbadensis leafjuice, Blue 1 (CI 42090), Yellow 5 (CI 19140), and the sodium isostearyl lactylate are added and the batch mixed until uniform. The batch is further cooled. At 30-35° C., the product is transferred to a chilling tank. The fragrance is added to the chilled product. The isobutane and the isopentane are then metered into the chilled product as known in the art.

In the shave gel formulation of Table 1, the ingredients generally act as follows. The water acts as a solvent. The carbomer acts as a gellant and suspending agent. The propylene glycol acts as a humectant. The hydroxypropyl guar acts as a lubricant and stabilizer. The methylparaben acts as a preservative. The palmitic acid acts as an emollient and emulsifier. The triethanolamine acts as an emulsifier and a neutralizer. The isopropyl palmitate acts as an emollient and lubricant. The Triclosan acts as an antimicrobial agent. The aloe barbadensis leaf juice acts is a botanical extract. The Blue 1 (CI 42090), Yellow 5 (CI 19140) are colorants. The sodium isostearyl lactylate acts as a humectant and an emulsifier. The fragrance imparts an odor. The isobutane and isopentane act as a propellant. As the propellant volatilizes after the formulation is dispensed and rubbed on the skin, for example, it turns from a gel form into a foam lather.

All of the ingredients listed in Table 1 are not necessary for forming an adequate post-foaming shaving formulation. For example, certain shaving formulation embodiments may include carbomer, hydroxypropyl guar, palmitic acid, triethanolamine, and propellant in effective amounts. Other ingredients that provide similar functions may be substituted, as well as desired additives such as, for example, preservatives, fragrance, colorants, moisturizers, cleansing agents, etc.

It will, of course, be understood that modifications of the present invention, in its various aspects, will be apparent to those skilled in the art. For instance, the size and shape of the illustrated tubes and caps may be varied. Other embodiments are also possible, their specific features depending upon the particular application. Therefore, the scope of the invention should not be limited by the particular embodiments herein described but should be defined by the appended claims and equivalents thereof.

What is claimed:

1. A product comprising:
a deformable tube including a neck region at one end, the neck region defining an interior passage;
a cap configured to be coupled to and removed from the neck region;
a post-foaming composition contained in the tube and adapted to be delivered from the tube through the interior passage in the neck region upon the application of force to the tube; and
the cap including a protuberance configured to extend into the interior passage when the cap is coupled to the neck region.

2. The product of claim 1, wherein the post-foaming composition comprises a cosmetic composition selected from the group consisting of a shaving composition, a hair styling composition, a facial wash composition, a body wash composition, a body moisturizing composition, and a make-up composition.

3. The product of claim 1, wherein the neck region includes a threaded portion, and wherein the cap includes a threaded portion adapted to fit over the neck region threaded portion.

4. The product of claim 1, wherein the protuberance is configured to extend through the interior passage in the neck region when the cap is coupled to the neck region.

5. The product of claim 1, wherein the tube is formed from a material comprising a metal.

6. The product of claim 1, wherein the tube is formed from a material comprising aluminum.

7. The product of claim 1, the tube including a body region coupled to the neck region, the body region including an interior chamber in communication with the interior passage in the neck region, wherein the post-foaming product is positioned in the interior chamber, and wherein the protuberance is configured to extend through the interior passage and into the interior chamber when the cap is coupled to the neck region.

8. The product of claim 1, wherein the protuberance is configured to inhibit the presence of an amount of the post-foaming composition from the interior passage in the neck region.

9. The product of claim 1, the interior passage defining a length, wherein the protuberance is configured to extend partially through the length of the interior passage.

10. The product of claim 1, the interior passage defining a length, wherein the protuberance is configured to extend through the length of the interior passage.

11. The product of claim 1, wherein the protuberance is integral to the cap.

12. The product of claim 1, the interior passage defining a length, wherein the protuberance is configured to extend through the length of the interior passage.

13. The product of claim 1, wherein the post-foaming composition contained in the tube includes 2 to 6 weight percent propellant.

14. A product comprising:
a deformable tube;
a neck region on the tube;
a chamber in the tube and extending into the neck region;
a cap configured to fit on the neck region and over an opening in the neck region;
a protrusion coupled to the cap, the protrusion configured to extend into the opening in the neck region when the cap is fit on the neck region and over the opening in the neck region; and
a cosmetic composition positioned in the chamber, the cosmetic composition comprising a post-foaming composition.

15. The product of claim 14, further comprising a leash configured to couple the cap to the tube.

16. The product of claim 14, wherein the neck region defines a length, and wherein the protuberance is configured to extend through at least one half of the length of the neck region.

17. The product of claim 14, wherein the post-foaming composition comprises:
2-6 wt % propellant; and
effective amounts of a carbomer, hydroxypropyl guar, palmitic acid, and triethanolamine.

18. A method comprising:
providing a tube containing a post-forming composition therein, the tube including a neck region; and
inserting a removeable cap over at least a portion of the neck region;
wherein the inserting a cap also includes inserting a protuberance coupled to the cap into an interior passage in the neck region, the protuberance configured to inhibit the presence of an amount of the post-foaming composition from the interior passage of the neck region.

19. The method of claim 18, wherein the post-foaming composition is a cosmetic composition selected from the group consisting of a shaving composition, a hair styling composition, a facial wash composition, a body wash composition, a body moisturizing composition, and a make-up composition.

20. The method of claim 18, wherein the post-foaming composition is a shaving gel.
